(19) United States
(12) Patent Application Publication
(10) Pub. No.: US 2026/0146976 A1
(43) Pub. Date: May 28, 2026

(54) WORKFLOW FOR INJECTABLE SUBSTANCES WHEN USING LIQUID CHROMATOGRAPHY TESTING

(71) Applicant: Waters Technologies Corporation, Milford, MA (US)

(72) Inventors: Sylvain Gilles Cormier, Charlton, MA (US); Michael O. Fogwill, Uxbridge, MA (US); William G. Foley, Plymouth, MA (US)

(21) Appl. No.: 19/399,888

(22) Filed: Nov. 25, 2025

Related U.S. Application Data
(60) Provisional application No. 63/725,194, filed on Nov. 26, 2024.

(51) Int. Cl. G01N 30/24; G01N 30/18; G01N 30/20

(52) U.S. Cl. CPC G01N 30/24; G01N 30/18; G01N 30/20

(57) ABSTRACT

A method for performing liquid chromatography includes receiving, by a receptor of a liquid chromatography sample manager, an original capped vial containing an injectable substance, processing, by an automated system of the liquid chromatography sample manager without human intervention, the injectable substance, and injecting, by the automated system of the liquid chromatography sample manager without human intervention, the injectable substance into a chromatographic flow for analysis. A liquid chromatography sample manager includes an automated system configured to, without human intervention, process the injectable substance; and inject the injectable substance into a chromatographic flow for analysis.

### RELATED APPLICATION

This application claims priority to U.S. Provisional Patent Application No. 63/725,194 filed on November 26, 2024 and titled “Workflow for Injectable Substances when Using Liquid Chromatography Testing” the entirety of which is incorporated by reference herein.

### FIELD OF THE INVENTION

The disclosed technology generally relates to liquid chromatography. More particularly, the technology relates to methods and systems for workflows for injectable substances when using liquid chromatography (LC) testing.

### BACKGROUND

There is a need in the art of liquid chromatography (LC) for improved solutions to apply in quality assurance and quality control (QA/QC) labs for injectable substances. Injectable substance samples often require dilution and injection to complete the QA/QC parts of the manufacturing process. Traditional workflows require manual or automated dilution of the final product followed by injection into an LC system. This requires several manual transfers from an original packaging to a dilution container, and from a dilution container to LC vials which are then placed on instrument trays which are finally put into an LC sample manager. All of this takes time and increases the possibility of error through manual intervention.

Therefore, improved devices and methods for performing LC testing on injectable substances would be well received in the art.

### SUMMARY

In one aspect, a method for performing liquid chromatography includes receiving, by a receptor of a liquid chromatography sample manager, an original capped vial containing an injectable substance; processing, by an automated system of the liquid chromatography sample manager without human intervention, the injectable substance; and injecting, by the automated system of the liquid chromatography sample manager, the injectable substance into a chromatographic flow for analysis.

Additionally or alternatively, the method includes piercing, by an automated needle system of the liquid chromatography sample manager, a septum of the original capped vial.

Additionally or alternatively, the method includes diluting, by the automated system of the liquid chromatography sample manager, the injectable substance. The diluting may include drawing, by the automated system of the liquid chromatography sample manager, the injectable substance from the original capped vial. The diluting may further include delivering, by the automated system of the liquid chromatography sample manager, the injectable substance into a dilution system and/or diluting, by the automated system of the liquid chromatography sample manager, the injectable substance with the dilution system.

Additionally or alternatively, the injecting includes drawing, by the automated system of the liquid chromatography sample manager, the diluted injectable substance from the dilution system. The injecting may further include injecting, by the automated system of the liquid chromatography sample manager, the diluted injectable substance into the chromatographic flow for analysis.

Additionally or alternatively, the method includes analyzing the diluted injectable substance by performing chromatographic separation on the injectable substance and detecting and/or quantifying separated constituent parts of the injectable substance.

Additionally or alternatively, the piercing is performed by a puncture needle of the automated needle system, and wherein the drawing is performed by a sample needle located within the puncture needle while the piercing needle remains within the original capped vial.

Additionally or alternatively, the original capped vial is at least 110 mm tall.

In another aspect, a method for performing liquid chromatography, further includes receiving, by a liquid chromatography sample manager, batch of original capped vials, each containing an injectable substance; processing, by an automated system of the liquid chromatography sample manager without human intervention, the batch; and injecting, by the automated system of the liquid chromatography sample manager, the injectable substance from at least one of the original capped vials of the batch of original capped vials into a chromatographic flow for analysis.

In another aspect, a liquid chromatography sample manager includes a receptor configured to receive an original capped vial containing an injectable substance; and an automated system configured to, without human intervention: process the injectable substance; and inject the injectable substance into a chromatographic flow for analysis.

Additionally or alternatively, the automated system further includes an automated needle system configured to pierce a septum of the original capped vial.

Additionally or alternatively, the automated system is further configured to dilute the injectable substance.

Additionally or alternatively, the automated system is further configured to draw the injectable substance from the original capped vial.

Additionally or alternatively, the automated system further includes a dilution system configured to dilute the injectable substance, and wherein the automated system is further configured to deliver the injectable substance into the dilution system.

Additionally or alternatively, the automated system is further configured to draw the diluted injectable substance from the dilution system.

Additionally or alternatively, the original capped vial is at least 110 mm tall.

Additionally or alternatively, the automated needle system further includes a puncture needle and a sample needle.

In another aspect, a liquid chromatography system includes a liquid chromatography sample manager includes a receptor configured to receive an original capped vial containing an injectable substance; and an automated system configured to, without human intervention: process the injectable substance; and inject the injectable substance into a chromatographic flow for analysis. The liquid chromatography system further includes a solvent delivery system in fluidic communication with the liquid chromatography sample manager; a chromatography column located downstream from the liquid chromatography sample manager; and a detector located downstream from the chromatography column.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 depicts a schematic representation of a liquid chromatography system, in accordance with one embodiment.

FIG. 2 depicts a workflow for injectable substances when using liquid chromatography testing in accordance with a prior art method.

FIG. 3 depicts a workflow for injectable substances when using liquid chromatography testing, in accordance with one embodiment.

FIG. 4 depicts a plurality of original capped vials containing injectable substances, in accordance with one embodiment.

FIG. 5 depicts a schematic representation of a sample manager for a liquid chromatography system, in accordance with one embodiment.

FIG. 6 depicts a method for performing liquid chromatography on an injectable substance, in accordance with one embodiment.

FIG. 7 depicts another method for performing liquid chromatography on an injectable substance, in accordance with one embodiment.

### DETAILED DESCRIPTION

Reference in the specification to an embodiment or example means that a particular feature, structure or characteristic described in connection with the embodiment or example is included in at least one embodiment or example of the teaching. References to a particular embodiment or example within the specification do not necessarily all refer to the same embodiment or example.

The present teaching will now be described in detail with reference to exemplary embodiments or examples thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. Moreover, features illustrated or described for one embodiment or example may be combined with features for one or more other embodiments or examples. Those of ordinary skill having access to the teaching herein will recognize additional implementations, modifications, and embodiments, as well as other fields of use, which are within the scope of the present disclosure as described herein.

In brief overview, embodiments described herein provide for creating a sample manager that is capable of performing sampling, vial puncturing, and sample drawing from the original injectable packaging, followed by the dilution of the production liquid and injection of the diluted sample. The automation of the dilution into the sample manager as disclosed herein is configured to minimize errors cause by human intervention and improve the overall performance of the LC system and the ensuing results.

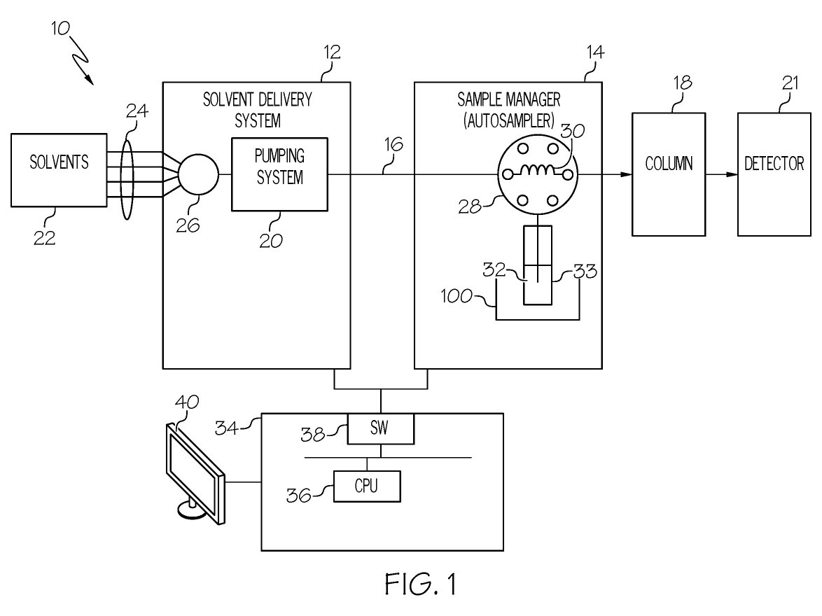

The features of the sample delivery system and sample manager described herein may be applicable to any liquid chromatography system configured to deliver samples into a chromatographic flow stream. As one example, FIG. 1 shows an embodiment of a liquid chromatography system 10 for separating a mixture into its constituents. The liquid chromatography system 10 includes a solvent delivery system 12 in fluidic communication with a sample manager 14 (also called an injector or an autosampler) through tubing 16. The sample manager 14 is in fluidic communication with a chromatographic column 18. A detector 21 for example, a mass spectrometer, is in fluidic communication with the column 18 to receive the elution.

The solvent delivery system 12 includes a pumping system 20 in fluidic communication with solvent reservoirs 22 from which the pumping system 20 draws solvents (liquid) through tubing 24. In one embodiment, the pumping system 20 is embodied by a low-pressure mixing gradient pumping system having two pumps fluidically connected in series. In the low-pressure gradient pumping system, the mixing of solvents occurs before the pump, and the solvent delivery system 12 has a mixer 26 in fluidic communication with the solvent reservoirs 22 to receive various solvents in metered proportions. This mixing of solvents (mobile phase) composition that varies over time (i.e., the gradient).

The pumping system 20 is in fluidic communication with the mixer 26 to draw a continuous flow of gradient therefrom for delivery to the sample manager 14. Examples of solvent delivery systems that can be used to implement the solvent delivery system 12 include, but are not limited to, the ACQUITY Binary Solvent Manager and the ACQUITY Quaternary Solvent Manager, manufactured by Waters Corp. of Milford, Mass.

The sample manager 14 may include an injector valve 28 having a sample loop 30. The sample manager 14 operates in one of two states: a load state and an injection state. In the load state, the position of the injector valve 28 is such that the sample manager loads the sample 32 into the sample loop 30. The sample 32 is drawn from a vial contained by a sample vial carrier. "Sample vial carrier" herein means any device configured to carry a sample vial such as a well plate, sample vial carrier, or the like. In the injection state, the position of the injector valve 28 changes so that the sample manager 14 introduces the sample in the sample loop 30 into the continuously flowing mobile phase from the solvent delivery system. The mobile phase thus carries the sample into the column 18. In other embodiments, a flow through needle (FTN) may be utilized instead of a Fixed-Loop sample manager. Using an FTN approach, the sample may be pulled into the needle and then the needle may be moved into a seal. The valve may then be switched to make the needle in-line with the solvent delivery system.

The liquid chromatography system 10 further includes a data system 34 that is in signal communication with the solvent delivery system 12 and the sample manager 14. The data system 34 has a processor 36 and a switch 38 (e.g. an Ethernet switch) for handling signal communication between the solvent delivery system 12 and sample manager 14, as described herein. Signal communication among the various systems and instruments can be electrical or optical, using wireless or wired transmission. A host computing system 40 is in communication with the data system 34 by which a technician can download various parameters and profiles (e.g., an intake velocity profile) to the data system 34.

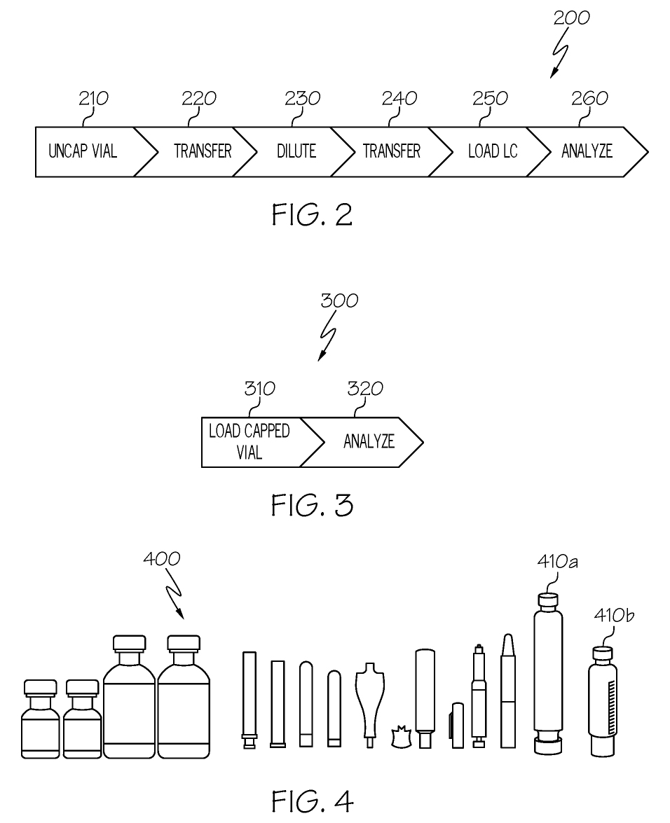

FIG. 2 depicts a workflow 200 for injectable substances when using liquid chromatography testing in accordance with a prior art method. As shown, the various steps in a prior art workflow require manual intervention at various stages, including a first stage 210 of uncapping the vial, a second stage 220 of placing some of the sample in a dilution container. A third stage 230 of the workflow 200 includes diluting the sample in the dilution container. Once diluted, the diluted sample is then transferred at a fourth stage 240 into a container that is capable of being interacted with by a liquid chromatography system. Then a fifth stage 250 includes loading such a container, containing the diluted sample, into the liquid chromatography system. Finally, the diluted sample is analyzed at a sixth stage 260. In such a workflow, the manual stages 210, 220, 230, 240 in particular are error prone, incur high labor cost, and are especially painful when the sample is light-sensitive, for example. In many instances, it has been shown that high error rates result in such a manual system.

FIG. 3 depicts a workflow 300 for injectable substances when using liquid chromatography testing, in accordance with one embodiment. In contrast to the prior art workflow 200, the workflow 300 contemplated by the present invention includes a first stage 310 of loading an original capped vial containing an injectable substance into a sample manager or other automated system, such as the sample manager 14. The workflow 300 then includes using the automation within the sample manager 14 to simply process and analyze the injectable substance in a second and final stage 320, without any human intervention or interaction (other than the placing of the original capped vial into the sample manager). To enable direct analysis from the formulated injectable, the LC sample compartment may be (as described herein below): adapted to pierce the vial septum; modified to include a dilution system; and including a reception system that is increased in height to accept tall injectable vials.

FIG. 4 depicts a plurality of original capped vials 400 containing injectable substances, in accordance with one embodiment. As shown, an “original capped vial” as defined herein means a capped vial containing an injectable substance in its original packaged form, as produced by the injectable manufacturer. The “original capped vial” as defined herein is in a vial that is configured for performing injection by a medical provider or professional using the original capped vial. Various examples of vials are shown in FIG. 4 which fit this definition. For example, a first capped vial 410a is shown having a relatively tall container or vial. Another shorter capped vial 410b is also shown. In various embodiments, the “original capped vials” described herein may have a height of 100mm, 110mm, 120 mm or more, for example. Accepting vials of such heights may require the raising of receiver systems in prior art LC processing systems and sample managers.

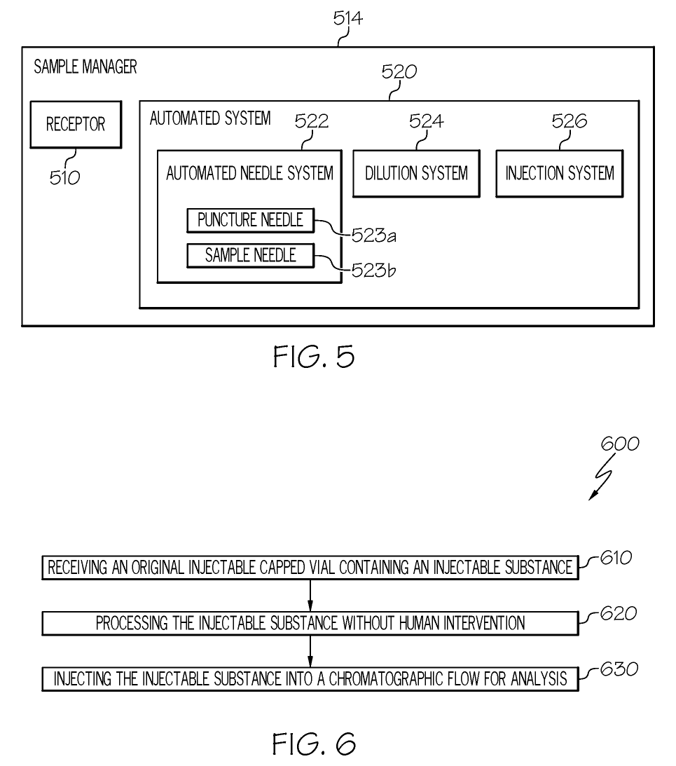

FIG. 5 depicts a schematic representation of a sample manager 514 for a liquid chromatography system, such as the system 10 described herein above, in accordance with one embodiment. The liquid chromatography sample manager 514 includes a receptor 510 configured to receive an original capped vial containing an injectable substance, such as one of the original capped vials 400 shown in FIG. 4. The liquid chromatography sample manager 514 further includes an automated system 520 configured to, without human intervention both process the injectable substance, and inject the injectable substance into a chromatographic flow for analysis.

As shown, the automated system 520 further includes an automated needle system 522 configured to pierce a septum of the original capped vial. The automated needle system 522 further includes a puncture needle 523a configured to puncture a septum in the original capped vial, and a sample needle 523b configured to be inserted into the original capped vial in order to draw the sample therefrom.

The automated system 520 may further include a dilution system 524 configured to dilute the injectable substance. The dilution system 524 and/or the automated system 520 may be further configured to deliver the injectable substance into the dilution system via, for example, the sample needle 523b. The dilution system 524 may include a separate dilution container, well or the like, which may be configured to receive both the injectable substance sample and a dilution substance.

The automated system 520 may further include an injection system 526 which may be configured to inject the diluted injectable substance into an LC stream for analysis, separation and/or detection. For example, the injection system 526 may include a separate draw needle or may use the sample needle 523b for drawing and injecting the diluted injectable substance.

FIG. 6 depicts a method 600 for performing liquid chromatography on an injectable substance, in accordance with one embodiment. The method 600 includes a first step 610 of receiving, by for example a receptor or receptor system of a liquid chromatography sample manager, an original capped vial containing an injectable substance. The method 600 includes a step 620 of processing, by an automated system of the liquid chromatography sample manager without human intervention, the injectable substance, and a final step 630 of injecting, by the automated system of the liquid chromatography sample manager, the injectable substance into a chromatographic flow for analysis.

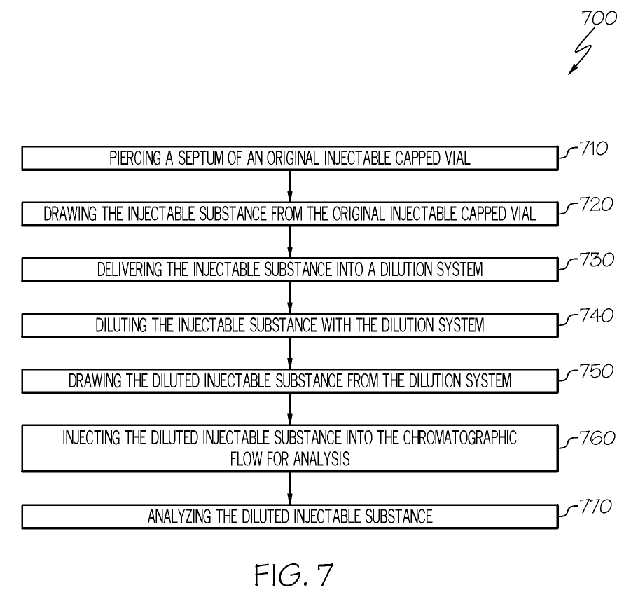

FIG. 7 depicts another method 700 for performing liquid chromatography on an injectable substance, in accordance with one embodiment. The method 700 may be a more specific embodiment for encapsulating the step 620 of the method 600 of processing the injectable substance without human intervention. Thus, the method 700 includes the steps which may be performed in an automated manner by a sample manager in order to process a received original capped vial.

The method 700 may include a first step 710 of piercing, by an automated needle system of the liquid chromatography sample manager, a septum of the original injectable capped vial. The method 700 may then include a step 720 of drawing, by the automated system of the liquid chromatography sample manager, the injectable substance from the original injectable capped vial. The method 700 may then include a step 730 of delivering, by the automated system of the liquid chromatography sample manager, the injectable substance into a dilution system, and a further step 740 of diluting, by the automated system of the liquid chromatography sample manager, the injectable substance with the dilution system. The method 700 may then include a step 750 of drawing, by the automated system of the liquid chromatography sample manager, the diluted injectable substance from the dilution system. Finally, the method 700 may include a step 760 of injecting, by the automated system of the liquid chromatography sample manager, the diluted injectable substance into the chromatographic flow for analysis, and a step 770 of analyzing the diluted injectable substance by performing chromatographic separation on the injectable substance and detecting and/or quantifying separated constituent parts of the injectable substance. Thus, the entirety of the processing of the injectable substance from the original capped vial may be performed without human intervention, once the sample manager receives the original capped vial.

While the above described embodiments have depicted the process of receiving an injectable substance within an original capped vail for processing, it should be understood that methods contemplated herein may further be configured to process and receive a batch of capped vials for automated processing by the sample manager. Thus, methods contemplated may include receiving, by a liquid chromatography sample manager, batch of original capped vials, each containing an injectable substance. Methods may include processing, by an automated system of the liquid chromatography sample manager without human intervention, the batch. Such processing may include, for example, the removing one original capped vail from the batch at a time for processing. Methods may further include injecting, by the automated system of the liquid chromatography sample manager, the injectable substance from at least one of the original capped vials of the batch of original capped vials into a chromatographic flow for analysis.

While various examples have been shown and described, the description is intended to be exemplary, rather than limiting and it should be understood by those of ordinary skill in the art that various changes in form and detail may be made therein without departing from the scope of the invention as recited in the accompanying claims.

What is claimed is:

1. A method for performing liquid chromatography comprising:
receiving, by a receptor of a liquid chromatography sample manager, an original capped vial containing an injectable substance;
processing, by an automated system of the liquid chromatography sample manager without human intervention, the injectable substance; and
injecting, by the automated system of the liquid chromatography sample manager, the injectable substance into a chromatographic flow for analysis.

2. The method of claim 1, further comprising:
piercing, by an automated needle system of the liquid chromatography sample manager, a septum of the original capped vial.

3. The method of claim 2, further comprising:
diluting, by the automated system of the liquid chromatography sample manager, the injectable substance.

4. The method of claim 3, wherein the diluting further comprises:
drawing, by the automated system of the liquid chromatography sample manager, the injectable substance from the original capped vial.

5. The method of claim 4, wherein the diluting further comprises:
delivering, by the automated system of the liquid chromatography sample manager, the injectable substance into a dilution system; and
diluting, by the automated system of the liquid chromatography sample manager, the injectable substance with the dilution system.

6. The method of claim 5, wherein the injecting further comprises:
drawing, by the automated system of the liquid chromatography sample manager, the diluted injectable substance from the dilution system.

7. The method of claim 6, wherein the injecting further comprises:
injecting, by the automated system of the liquid chromatography sample manager, the diluted injectable substance into the chromatographic flow for analysis.

8. The method of claim 7, further comprising:
analyzing the diluted injectable substance by performing chromatographic separation on the injectable substance and detecting and/or quantifying separated constituent parts of the injectable substance.

9. The method of claim 4, wherein the piercing is performed by a puncture needle of the automated needle system, and wherein the drawing is performed by a sample needle located within the puncture needle while the piercing needle remains within the original capped vial.

10. The method of claim 1, wherein the original capped vial is at least 110 mm tall.

11. A method for performing liquid chromatography, further comprising:
receiving, by a liquid chromatography sample manager, batch of original capped vials, each containing an injectable substance;
processing, by an automated system of the liquid chromatography sample manager without human intervention, the batch; and
injecting, by the automated system of the liquid chromatography sample manager, the injectable substance from at least one of the original capped vials of the batch of original capped vials into a chromatographic flow for analysis.

12. A liquid chromatography sample manager comprising:
a receptor configured to receive an original capped vial containing an injectable substance; and
an automated system configured to, without human intervention:
process the injectable substance; and
inject the injectable substance into a chromatographic flow for analysis.

13. The liquid chromatography sample manager of claim 12, wherein the automated system further includes an automated needle system configured to pierce a septum of the original capped vial.

14. The liquid chromatography sample manager of claim 13, wherein the automated system is further configured to dilute the injectable substance.

15. The liquid chromatography sample manager of claim 14, wherein the automated system is further configured to draw the injectable substance from the original capped vial.

16. The liquid chromatography sample manager of claim 15, wherein the automated system further includes a dilution system configured to dilute the injectable substance, and wherein the automated system is further configured to deliver the injectable substance into the dilution system.

17. The liquid chromatography sample manager of claim 16, wherein the automated system is further configured to draw the diluted injectable substance from the dilution system.

18. The liquid chromatography sample manager of claim 12, wherein the original capped vial is at least 110 mm tall.

19. The liquid chromatography sample manager of claim 12, wherein the automated needle system further includes a puncture needle and a sample needle.

20. A liquid chromatography system comprising:
the liquid chromatography sample manager of claim 12; and
a solvent delivery system in fluidic communication with the liquid chromatography sample manager;
a chromatography column located downstream from the liquid chromatography sample manager; and
a detector located downstream from the chromatography column.
